(19) United States
(12) Patent Application Publication
(10) Pub. No.: US 2012/0056824 A1
(43) Pub. Date: Mar. 8, 2012

(54) COMPOSITE STRUCTURE AND TOUCH DEVICE

(75) Inventors: Lun-Feng Liu, Taoyuan County (TW); Huai-An Li, Taoyuan County (TW); Der-Chun Wu, Taoyuan County (TW)

(73) Assignee: CHUNGHWA PICTURE TUBES, LTD., Taoyuan (TW)

(21) Appl. No.: 12/915,028

(22) Filed: Oct. 29, 2010

(30) Foreign Application Priority Data
Sep. 2, 2010 (TW) 99217031

(51) Int. Cl. G06F 3/041; B32B 3/30; B32B 3/02

(52) U.S. Cl. 345/173; 428/157

(57) ABSTRACT

A composite structure and a touch device are provided. The composite structure includes a substrate and a transparent conductive pattern layer. The substrate has a central area and a peripheral area. The transparent conductive pattern layer is disposed on the substrate and has a plurality of recess-portions. The recess-portions are disposed on a side surface of the transparent conductive pattern layer away from the substrate and at least located in the peripheral area. A depth of each of the recess portions is smaller than or equal to a thickness of the transparent conductive pattern layer. A width of each of the recess portions is between 100 μm and 1000 μm, and the recess portions are arranged in a ring-shape or arranged in an array.

### CROSS-REFERENCE TO RELATED APPLICATION

This application claims the priority benefit of Taiwan application serial no. 99217031, filed on Sep. 2, 2010. The entirety of the above-mentioned patent application is hereby incorporated by reference herein and made a part of this specification.

### BACKGROUND

1. Field of the Invention

The invention relates to a touch device. Particularly, the invention relates to a touch device having a high sensing accuracy.

2. Description of Related Art

In recent years, various electronic products are developed to have features of easy operation, small size and large screen size. Particularly, requirements in sizes and screen sizes of portable electronic products are strict. Therefore, in many electronic products, a touch device and a liquid crystal display panel are generally integrated to save a space required by a keyboard or control buttons, so as to expand a configurable area of a screen.

Presently, the touch devices are approximately grouped into resistive, capacitive, infrared and ultrasonic touch devices, wherein the resistive touch devices and the capacitive touch devices are commonly used products. Regarding the capacitive touch device, a main operation principle thereof is to generate an electric field in touch electrodes, and when a conductor (for example, a user's finger) contacts the touch device, a tiny capacitance variation is generated, so that by measuring a position of the capacitance variation, coordinates of a contact point on the touch panel can be determined. Moreover, since the capacitive touch device has a multi-touch function and can provide a humanized operation mode, it is popular in the market.

Regarding the resistive touch device, originally separated conductive layers are contacted and electrically connected due to pressure, and a sensing signal is generated at the touch position, and then coordinates of the touch position on the panel is determined according to the sensing signal. Moreover, the resistive touch device can be operated by any medium, so that utilization convenience of the resistive touch device is improved. In addition, the cost of the resistive touch device is relatively low, and the technique thereof is mature, so that a market share of the resistive touch device is relatively high.

Generally, in either of the resistive touch device or the capacitive touch device, a large-area electrode pattern is used as a sensing device, and touch coordinates are obtained to notify the tough device replying a touch operation of the user. However, regardless of the resistive touch device or the capacitive touch device, at an edge (i.e. a peripheral area) of a sensing area, a calculation result is liable to be different to an actual touch position due to uneven impedance of the electrode pattern, i.e. a sensing accuracy is not as good as expectation. Therefore, it is an important issue to improve the sensing accuracy of the touch device at the peripheral area in design of the touch device.

### SUMMARY OF THE INVENTION

The invention is directed to a composite structure, which can improve an electrical state of a peripheral area.

The invention is directed to a touch device, which can improve a sensing accuracy of a peripheral area.

The invention provides a composite structure including a substrate and a transparent conductive pattern layer. The substrate has a central area and a peripheral area. The transparent conductive pattern layer is disposed on the substrate and has a plurality of recess portions. The recess portions are disposed on a side surface of the transparent conductive pattern layer away from the substrate and at least located in the peripheral area.

In an embodiment of the invention, a depth of each of the recess portions is smaller than or equal to a thickness of the transparent conductive pattern layer.

In an embodiment of the invention, a width of each of the recess portions is between 100 μm and 1000 μm.

In an embodiment of the invention, the recess portions are arranged in a ring-shape, or arranged in an array.

The invention provides a touch device including a composite structure and a transparent conductive layer. The composite structure includes a substrate and a transparent conductive pattern layer. The substrate has a central area and a peripheral area. The transparent conductive pattern layer is disposed on the substrate and has a plurality of recess portions. The recess portions are disposed on a side surface of the transparent conductive pattern layer away from the substrate and at least located in the peripheral area. The transparent conductive layer is disposed at a side of the composite structure.

In an embodiment of the invention, a depth of each of the recess portions is smaller than or equal to a thickness of the transparent conductive pattern layer.

In an embodiment of the invention, a width of each of the recess portions is between 100 μm and 1000 μm.

In an embodiment of the invention, the substrate has a first surface and a second surface opposite to the first surface, the transparent conductive pattern layer is disposed on the first surface, and the transparent conductive layer is disposed on the second surface.

In an embodiment of the invention, the touch device further includes a passivation layer disposed on the transparent conductive pattern layer for covering the transparent conductive pattern layer.

The invention provides a touch device including a first composite structure, a second substrate and a transparent conductive layer. The first composite structure includes a first substrate and a transparent conductive pattern layer. The first substrate has a central area and a peripheral area. The transparent conductive pattern layer is disposed on the first substrate and has a plurality of first recess portions. The first recess portions are disposed on a side surface of the transparent conductive pattern layer away from the first substrate and at least located in the peripheral area. The second substrate is disposed at a side of the first composite structure, and faces to the transparent conductive pattern layer. The transparent conductive layer is disposed on the second substrate and faces to the transparent conductive pattern layer, wherein a distance is maintained between the transparent conductive layer and the transparent conductive pattern layer, and the transparent conductive layer and the second substrate form a second composite structure.

In an embodiment of the invention, a depth of each of the first recess portions is smaller than or equal to a thickness of the transparent conductive pattern layer.

In an embodiment of the invention, a width of each of the first recess portions is between 100 μm and 1000 μm.

In an embodiment of the invention, the transparent conductive layer has a plurality of second recess portions, and the second recess portions are disposed on a side surface of the transparent conductive layer away from the second substrate.

According to the above descriptions, since the transparent conductive pattern layer has the recess portions at the peripheral area of the substrate, based on a concept that an impedance of the transparent conductive pattern layer is inversely proportional to a thickness of the transparent conductive pattern layer, current may flow along a path having a minimum impedance, i.e. the current flows through areas without the recess portions. In this way, an electrical state of the peripheral area is improved, so as to improve a sensing accuracy of the touch device at the peripheral area.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a composite structure according to an embodiment of the invention.

FIG. 2 is a top-view of a composite structure of FIG. 1.

FIG. 3 is a top-view of a composite structure according to another embodiment of the invention.

FIG. 4 is a cross-sectional view of a touch device according to an embodiment of the invention.

FIG. 5 is a cross-sectional view of a touch device according to another embodiment of the invention.

### DETAILED DESCRIPTION OF DISCLOSED EMBODIMENTS

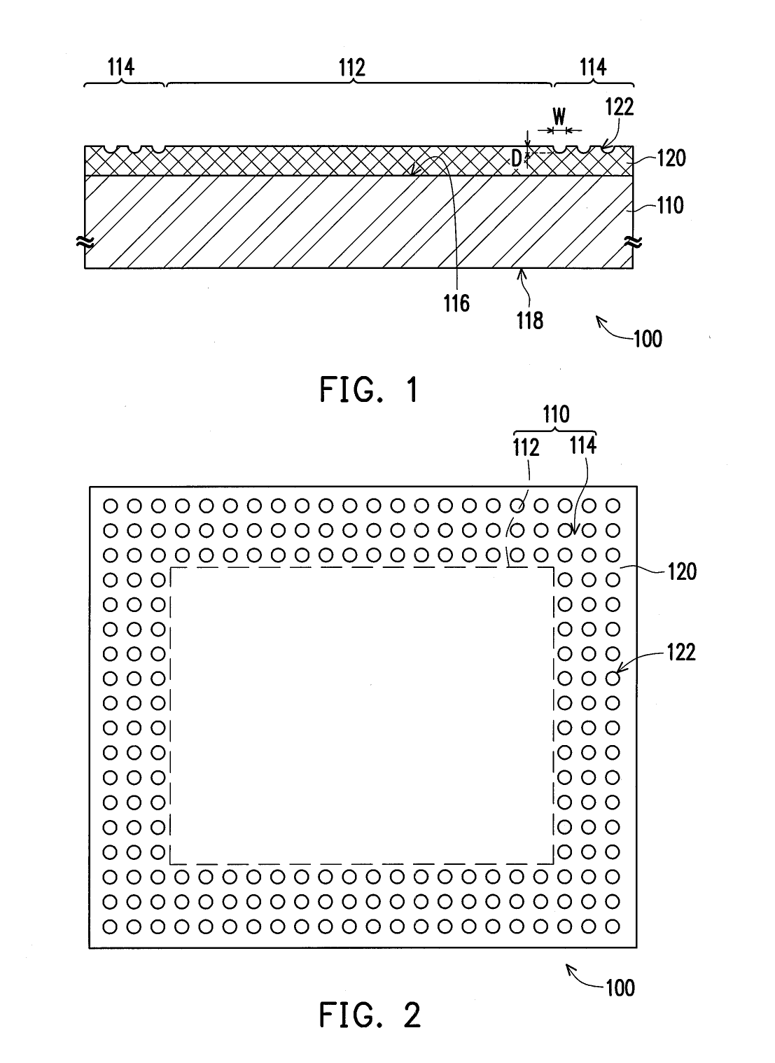

FIG. 1 is a cross-sectional view of a composite structure according to an embodiment of the invention. FIG. 2 is a top-view of the composite structure of FIG. 1. Referring to FIG. 1 and FIG. 2, in the present embodiment, the first composite structure 100 includes a first substrate 110 and a transparent conductive pattern layer 120. In detail, the first substrate 110 has a central area 112, a peripheral area 114 surrounding the central area 112, a first surface 116 and a second surface 118 opposite to the first surface 116. The transparent conductive pattern layer 120 is disposed on the first surface 116 of the first substrate 110, and has a plurality of recess portions 122. The recess portions 122 are disposed on a side surface of the transparent conductive pattern layer 120 away from the first substrate 110, and are at least located in the peripheral area 114 of the first substrate 110.

In detail, the recess portions 122 are arranged in a ring-shape in the peripheral area 114 of the first substrate 110, and a depth D of each of the recess portions 122 is, for example, smaller than or equal to a thickness of the transparent conductive pattern layer 120. It should be noticed that in FIG. 1, the depth D of each of the recess portions 122 is schematically illustrated to be smaller than the thickness of the transparent conductive pattern layer 120. In other embodiments, if the depth D of each of the recess portions 122 is equal to the thickness of the transparent conductive pattern layer 120, the recess portions 122 may expose a portion of the first surface 116 of the first substrate 110. Moreover, preferably, a width W of each of the recess portions 122 is, for example, between 100 μm and 1000 μm, and the recess portions 122 can be formed by an etching process. In addition, a material of the transparent conductive pattern layer 120 is, for example, indium tin oxide (ITO), indium zinc oxide (IZO) or other transparent conductive materials.

Generally, under a same film-forming condition, an impedance the transparent conductive pattern layer 120 is inversely proportional to a thickness of the transparent conductive pattern layer 120. Namely, the thicker the transparent conductive pattern layer 120 is, the lower the impedance of the transparent conductive pattern layer 120 is. Based on the above principle, it is known that areas where the recess portions 122 are located can be regarded as high-impedance areas, and areas (including the central area 112 and a portion of the peripheral area 114) without the recess portions 122 can be regarded as low-impedance areas. Since a current may flow along a path having a minimum impedance, i.e. flows through the low-impedance areas, an electrical state of the peripheral area 114 of the first substrate 110 is improved according to the design of the transparent conductive pattern layer 120.

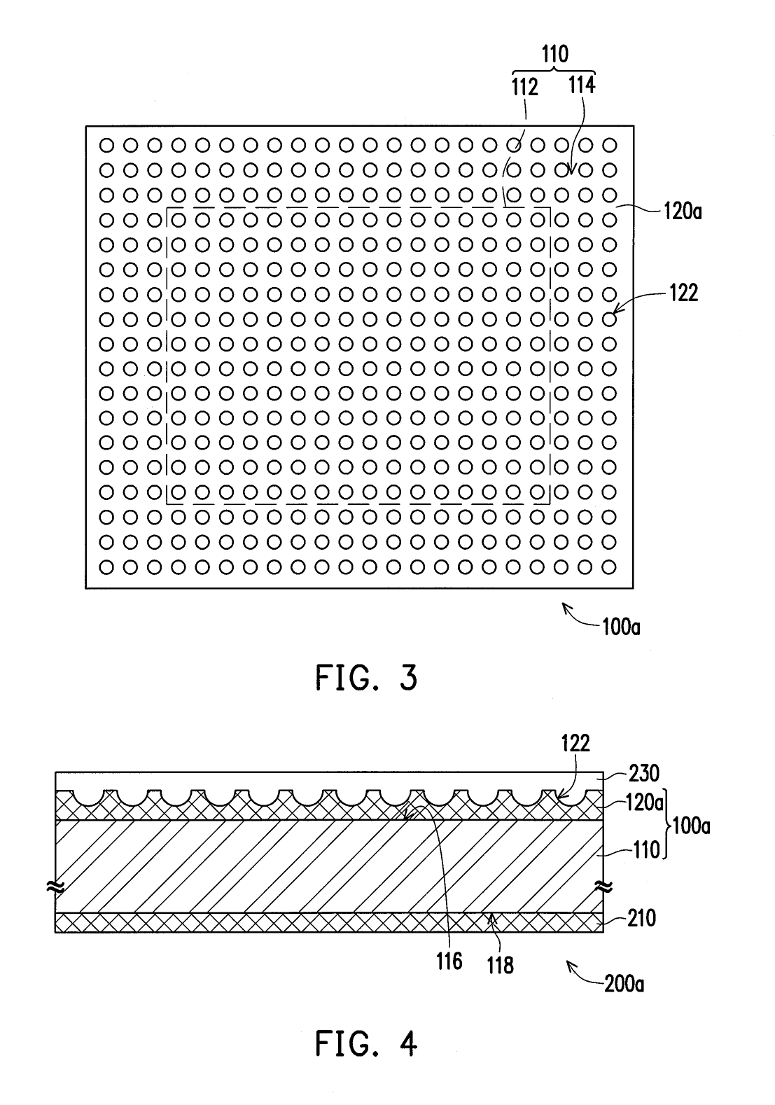

It should be noticed that positions and shapes of the recess portions 122 are not limited by the invention, although the aforementioned recess portions 122 are located in the peripheral area 114 of the first substrate 110, and shapes of the recess portions 122 are substantially arc-shapes, in other embodiments, referring to FIG. 3, the recess portions 122 of a transparent conductive pattern layer 120a of a first composite structure 100a can also be arranged in an array in the central area 112 and the peripheral area 114 of the first substrate 110. Alternatively, in other embodiments that are not illustrated, the shapes of the recess portions 122 can also be squares or other polygons, and the above examples are still belonged to the technical patterns of the invention without departing a protection range of the invention.

It should be noticed that reference numbers of the components and a part of contents of the aforementioned embodiment are also used in the following embodiment, wherein the same reference numbers denote the same or like components, and descriptions of the same technical contents are omitted. The aforementioned embodiment can be referred for descriptions of the omitted parts, so that detailed descriptions thereof are not repeated in the following embodiment.

FIG. 4 is a cross-sectional view of a touch device according to an embodiment of the invention. In the present embodiment, the touch device 200a includes the first composite structure 100a and a transparent conductive layer 210, wherein the touch device 200a is, for example, a capacitive touch device, a panel or a sketchpad. In the present embodiment, the touch device 200a is, for example, a capacitive touch device. In detail, the first composite structure 100a includes the first substrate 110 and the transparent conductive pattern layer 120a, wherein the recess portions 122 are arranged in an array in the central area 112 and the peripheral area 114 of the first substrate 110. Certainly, in other embodiments, the recess portions 122 can also be arranged in a ring-shape in the peripheral area 114 of the first substrate 110. It should be noticed that in the present embodiment, structures, materials and relative positions of the first substrate 110 and the transparent conductive pattern layer 120a are similar to that of the first substrate 110 and the transparent conductive pattern layer 120 of FIG. 1, so that detailed descriptions thereof are not repeated.

The transparent conductive layer 210 is disposed at a side of the first composite structure 100a. In detail, the transparent conductive layer 210 is disposed on the first substrate 110 and covers the second surface 118. Moreover, the touch device 200a of the present embodiment further includes a passivation layer 230. The passivation layer 230 is disposed on the transparent conductive pattern layer 120a for covering and protecting the transparent conductive pattern layer 120a. A material of the passivation layer 230 is, for example, SiO₂ or other suitable materials.

In the present embodiment, since the touch device 200a has the first composite structure 100a, based on the concept that the impedance of the transparent conductive pattern layer 120a is inversely proportional to the thickness of the transparent conductive pattern layer 120a, the current may flow through areas without the recess portions 122, so that an electrical state of the peripheral area 114 is improved. In this way, a sensing accuracy of the touch device 200a at the peripheral area 114 is improved.

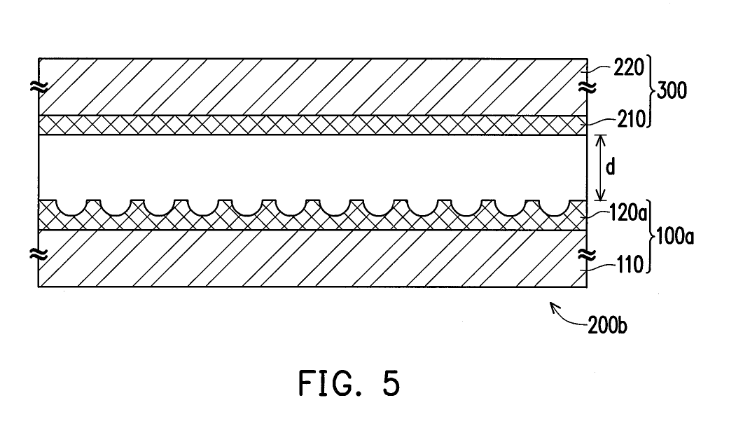

FIG. 5 is a cross-sectional view of a touch device according to another embodiment of the invention. The touch device 200b of the present embodiment is similar to the touch device 200a of FIG. 4, and a difference there between is that the touch device 200b of FIG. 5 is a resistive touch device. In detail, in the present embodiment, the touch device 200b further includes a second substrate 220, wherein the transparent conductive layer 210 is disposed on the second substrate 220, and faces to the transparent conductive pattern layer 120a. A distance d is maintained between the transparent conductive layer 210 and the transparent conductive pattern layer 120a, and the transparent conductive layer 210 and the second substrate 220 form a second composite structure 300. Spacers (not shown) can be disposed between the transparent conductive layer 210 and the transparent conductive pattern layer 120a to maintain the distance d, or only air can exist there between.

It should be noticed that when the touch device 200b is a four-wire resistive touch device, the transparent conductive layer 210 may also have a plurality of recess portions (not shown) as that does of the transparent conductive pattern layer 120a, wherein the recess portions are disposed on a side surface of the transparent conductive layer 210 away from the second substrate 220. In this way, the electrical states of the peripheral areas 114 of the first substrate 110 and the second substrate 220 can be effectively improved. If the touch device 200b is a five-wire resistive touch device, the transparent conductive layer 210 is only used for sensing, and does not have a function of generating an electric field, so that the transparent conductive layer 210 may selectively have the recess portions.

In summary, since the transparent conductive pattern layer has the recess portions at the peripheral area of the substrate, the current may flow along a path having a minimum impedance, i.e. the current flows through areas without the recess portions. In this way, an electrical state of the peripheral area is improved, so as to improve a sensing accuracy of the touch device at the peripheral area.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A composite structure, comprising:
a substrate, having a central area and a peripheral area; and
a transparent conductive pattern layer, disposed on the substrate and having a plurality of recess portions, wherein the recess portions are disposed on a side surface of the transparent conductive pattern layer away from the substrate and at least located in the peripheral area, a depth of each of the recess portions is smaller than or equal to a thickness of the transparent conductive pattern layer, a width of each of the recess portions is between 100 μm and 1000 μm, and the recess portions are arranged in a ring-shape or arranged in an array.

2. A touch device, comprising:
a composite structure, comprising:
a substrate, having a central area, a peripheral area, a first surface and a second surface opposite to the first surface; and
a transparent conductive pattern layer, disposed on the first surface of the substrate and having a plurality of recess portions, wherein the recess portions are disposed on a side surface of the transparent conductive pattern layer away from the substrate and are at least located in the peripheral area, a depth of each of the recess portions is smaller than or equal to a thickness of the transparent conductive pattern layer, and a width of each of the recess portions is between 100 μm and 1000 μm; and
a transparent conductive layer, disposed at a side of the composite structure and located on the second surface of the substrate.

3. The touch device as claimed in claim 2, further comprising a passivation layer disposed on the transparent conductive pattern layer for covering the transparent conductive pattern layer.

4. A touch device, comprising:
a first composite structure, comprising:
a first substrate, having a central area and a peripheral area; and
a transparent conductive pattern layer, disposed on the first substrate and having a plurality of first recess portions, wherein the first recess portions are disposed on a side surface of the transparent conductive pattern layer away from the first substrate and at least located in the peripheral area;
a second substrate, disposed at a side of the first composite structure, and facing to the transparent conductive pattern layer; and
a transparent conductive layer, disposed on the second substrate and facing to the transparent conductive pattern layer, wherein a distance is maintained between the transparent conductive layer and the transparent conductive pattern layer, and the transparent conductive layer and the second substrate form a second composite structure.

5. The touch device as claimed in claim 4, wherein a depth of each of the first recess portions is smaller than or equal to a thickness of the transparent conductive pattern layer.

6. The touch device as claimed in claim 4, wherein a width of each of the first recess portions is between 100 μm and 1000 μm.

7. The touch device as claimed in claim 4, wherein the transparent conductive layer has a plurality of second recess portions, and the second recess portions are disposed on a side surface of the transparent conductive layer away from the second substrate.
